(19) United States
(12) Patent Application Publication
(10) Pub. No.: US 2011/0155398 A1
(43) Pub. Date: Jun. 30, 2011

(54) Vehicle Fire Extinguisher

(75) Inventors: Gary F. Holland, Snohomish, WA (US); Paul H. Wierenga, Seattle, WA (US)

(73) Assignee: Aerojet-General Corporation, Redmond, WA (US)

(21) Appl. No.: 13/030,543

(22) Filed: Feb. 18, 2011

Related U.S. Application Data
(63) Continuation of application No. 10/825,076, filed on Apr. 15, 2004.
(60) Provisional application No. 60/463,485, filed on Apr. 15, 2003.

(51) Int. Cl. A62C 3/07

(52) U.S. Cl. 169/46; 169/62

(57) ABSTRACT

A solid propellant fire extinguisher or a hybrid fire extinguisher is incorporated into a vehicle fire suppression system. The system is activated according to at least one condition selected from the group consisting of acceleration, deceleration, speed, time, temperature, fuel, fuel level, fire, smoke, light transmittance and optical signature.

### CROSS-REFERENCE TO RELATED APPLICATION

This application is a continuation of U.S. patent application Ser. No. 10/825,076 that was filed on Apr. 15, 2004. U.S. Ser. No. 10/825,076 in turn claims the benefit of Provisional Application No. U.S. 60/463,485, filed Apr. 15, 2003. The disclosures of both U.S. Ser. No. 10/825,076 and U.S. 60/463,485 are fully incorporated herein by reference in their entireties.

### FIELD OF THE INVENTION

The present invention is related to fire suppression systems for vehicles and to the hybrid fire extinguisher used in the fire suppression system.

### BACKGROUND OF THE INVENTION

According to NFPA 1996 data, vehicle fires accounted for 21% of all fires reported to U.S. fire departments and for 14.2% of all civilian fire related deaths. The total property damage was in excess of $1.3 billion. Automobiles account for 74% of vehicle fires. The data also indicates that 80% of automobile fire deaths occur as a result of a rear impact collision. The higher percentage of fires resulting from a rear impact versus a frontal impact or engine compartment fire is due to the events that can occur during a rear impact collision. The likelihood of these events occurring increases with increasing velocity. Although the trunk area of the impacted vehicle is designed to crumple to absorb energy, during extremely high velocity impacts, the trunk area of some vehicles has been known to collapse forward of the rear axle. The fuel tank of a vehicle can be damaged as a result of this collapse, resulting in a fuel spill. The tank may be punctured, fractured or otherwise ruptured, which will cause a fuel spill, or the fuel may spill as a result of a leak in any fuel connection, or from a broken hose. Other fuel spills may be the result of a leak in the tank carried by the vehicle. In the event of a fuel spill from whatever cause, the fuel will spill onto the surface beneath the vehicle. If the vehicle is still moving, a trail of fuel is left behind and when the vehicle comes to a stop, fuel begins to puddle underneath the vehicle. The puddle of fuel can rapidly spread underneath the vehicle. In some cases, the fuel is ignited by sparks from sliding metal on the roadway or by a short in an electrical circuit. The ensuing fire rapidly spreads to the rest of the vehicle, engulfing the entire vehicle in minutes. Passengers that are unconscious or unable to leave the vehicle are at risk of being severely injured or killed as a result of the fire. Accordingly, if the proper fire suppression system could be developed, considerable safety benefits could be realized if such a system were made available to the public in new vehicles or as a retrofit system to existing vehicles.

Airbag inflators are designed to exhaust inert gases, typically either nitrogen or a mixture of nitrogen, water vapor, and carbon dioxide gas. These gases are effective fire suppressants. With the advent of a need for small and lightweight fire suppression systems, and a desire to replace Halon 1301, efforts have been made to apply solid propellant expertise to fire suppression. These efforts have resulted in a gas generator propellant ideally suited for fire suppression applications. Fire extinguishers using a solid propellant to generate inert fire suppression gases are known as Solid Propellant Fire Extinguishers (SPFE). Various inert and chemically active gas producing propellants have been developed. While SPFEs have many uses, one noted deficiency is the inability of providing a film or layer of a blanketing material on the surface of liquid fuels that can mean the prevention of re-ignition. The lack of a liquid fire suppressant in SPFEs also means that little cooling is produced by the fire suppressant.

As a result, alternative extinguisher technologies have been developed. A broad range of fire suppression applications can benefit from the increased cooling capacity or residual effects only a liquid suppressant can provide. One of these technologies relies on combining a solid propellant gas generator with a liquid fire suppressant. A fire extinguisher that uses a solid propellant gas generator to propel a fluid fire suppressant is known as a Hybrid Fire Extinguisher (HFE).

Hybrid fire extinguishers make use of a variety of gas or liquid fire suppressants, including FREON 22, FREON 32, HALON 1301, CO₂, ammonia, water and aqueous solutions, and fluorocarbons such as HFC-227ea (heptafluoropropane), hexafluoropropane and pentafluoropentane, or fluoroketone, such as perfluorbutyl trifluormethyl ketone. Hybrid fire extinguishers use a small quantity of solid propellant to produce inert gases. These inert gases can be generated from solid or liquid propellants or high-pressure gas cylinders, to pressurize, vaporize, and expel the liquid or gaseous fire suppressant from a tank. Various inert and chemically active hybrid fire suppression configurations have been developed. However, to date, there is no solid propellant fire extinguisher or hybrid fire extinguisher developed for vehicles. In particular, there is no solid propellant fire extinguisher or hybrid fire extinguisher developed that is ideally suited to extinguish and prevent reignition of fires attributable to vehicle collisions. The present invention fulfills this need and provides further related advantages.

### SUMMARY OF THE INVENTION

The present invention provides either a solid propellant fire extinguisher or a hybrid fire extinguisher for a vehicle fire suppression system. The present invention is related to the fire extinguisher with a surfactant, to a fire suppression system that uses a fire extinguisher and to a method of suppressing vehicle fires.

A hybrid fire extinguisher, according to the invention, includes a container that has a propellant and a fluid fire suppressant, wherein the propellant is functional to propel the fluid fire suppressant from the container. The fluid fire suppressant also includes a surfactant that is chosen to increase the film-forming, miscibility, or emulsifiability of the fluid fire suppressant with a fuel. The fuel can include gasoline or diesel, but is also inclusive of hydrocarbon fuels. The fire suppression system can be configured to activate automatically on a plural number of conditions that are indicative of a collision and/or fire to increase the reliability of the system.

A fire suppression system for a vehicle includes the fire extinguisher and one or more instruments, wherein the instruments can indicate a condition that will lead to the activation of the fire extinguisher. Conditions that may activate the fire suppression system include, but are not limited to, rapid acceleration or deceleration, speed or lack thereof, time, time delay, timed events or actions, temperatures indicative of a fire, smoke indicative of a fire, fuel level in tanks, fuel vapors indicating spilled fuel, and any other instrument that indicates a fire. The fire suppression system is connected to the instruments via a computer that can process the instrument signals to activate the fire suppression system based on a predetermined logical sequence.

A method according to the invention for suppressing vehicle fires includes the activation of the fire suppression system according to one condition from those listed above.

Representative vehicles include passenger automobiles, such as sedans, pickup trucks, vans, minivans, SUVs, station wagons, and the like. Vehicles can also mean buses, trucks, tanker trucks, railroad cars, or any other mode of transportation where the possibility of fire exists due to the spillage of fuel from tanks or vessels.

In one embodiment, a fire suppression system for a vehicle includes a propellant; a fluid fire suppressant; and a surfactant, wherein the propellant can generate gases that propel the fire suppressant and surfactant through a distribution system to a fire. In one embodiment, the propellant is activated based on instrument signals indicative of a vehicle collision and/or fire. The sensor may be an acceleration sensor. A timer delays activating the fire extinguishing system for a suitable time period to allow the vehicle to slow down or come to rest. The delay time is regulated according to the severity of the collision. For example, low energy collisions might have a shorter delay time as compared with collisions occurring at higher velocities. Severity of collisions may also be measured by the speed preceding the collision. In this manner, sufficient time is allowed for the vehicle to slow down or come to rest after a collision and before the fire suppression system is activated.

In another embodiment, a vehicle with an existing airbag may be retrofitted to include a fire suppression system. The system includes acceleration sensors that detect rapid acceleration and a processor that processes signals from the acceleration sensors to activate the airbag. The processor is also capable of activating either a solid propellant fire extinguisher or a hybrid fire extinguisher after a suitable delay period after the activation of the airbag.

In another embodiment of the present invention, a method for extinguishing vehicle fires is provided. The method includes detecting rapid acceleration indicative of a vehicle collision. It is to be appreciated that acceleration can also be negative acceleration or deceleration. For example, the motion experienced by a moving vehicle crashing into a stationary object can cause deceleration of the vehicle. On the other hand, a stationary vehicle can be struck from behind, causing positive acceleration of the vehicle. Both rapid acceleration and rapid deceleration (positive and negative acceleration) can indicate the need to activate a fire extinguisher. The method can include delaying the activation of either a solid propellant fire suppression system or a hybrid fire suppression system that is mounted on the vehicle. The delay of the activation of the suppression system is for a predetermined period of time after the collision to provide time for the vehicle to slow down or come to a stop.

In other embodiments of the invention, methods provide the firing logic to activate a fire extinguisher. In one method, the fire extinguisher is activated based on two independent and different or redundant modes of sensing a condition. For example, detection of rapid acceleration can be followed by detection of heat, smoke, or fire, before the fire extinguisher is activated. Heat, smoke, or fire can be sensed by optically or thermally sensitive instruments. Other embodiments include the use of a dash mounted switch that can manually activate the fire extinguisher, provided the firing logic allows the manual switch to be operable. In other embodiments, a manual switch can abort the functioning of the fire extinguisher. The firing logic can be provided with interlocks that will either allow or prevent the functioning of the fire extinguisher. The interlocks can rely on sensors that detect acceleration, deceleration, speed, time, temperature, fuel, fuel level, fire, smoke, light transmittance and optical signature or manual switches.

In the embodiments of the fire extinguishing system mentioned above, numerous piping configurations can be installed. For example, one embodiment provides a plurality of nozzles directed at the underside of the vehicle body located in proximity to the fuel tank. In this manner, any fuel fire may be quickly and effectively extinguished. The fire suppression system according to the present invention includes a surfactant that can form a film at the surface of the fuel/air interface to prevent ignition, or in the case where a fire has occurred and has been extinguished, to prevent reignition of the fuel. As used herein, “fuel” can mean any flammable liquid, including fuels, such as gasoline, but also includes fuels for other modes of transportation, and fuel also means any flammable liquid that is either used to propel a vehicle or that is carried by the vehicle in a tank.

The present invention provides one or more advantages including the ability to extinguish underbody fuel puddle fires. The system according to the invention prevents the fuel from reigniting once it has been extinguished or the system can prevent initial ignition of the fuel by providing a film or layer between the fuel/air interface. The system is able to detect a fire and automatically activate under the right circumstances or under manual control. The system fits into the existing vehicle with minor modifications. The system can be integrated into the vehicle's battery or other stored energy device if power is necessary to activate the fire suppression system. The system is designed to survive the rugged effects of being installed on a vehicle for 20 years or more and to reliably function when necessary. The system requires little or no maintenance during its installed life. The system performs a self-check or test periodically and can announce the status in the event the system needs attention or is no longer functional (health monitoring capability). All components of the system are safe to handle, install, and maintain.

A Hybrid Fire Extinguisher (HFE) according to the invention combines the benefits of a fluid fire suppressant and a chemically active or inactive solid propellant fire extinguisher (SPFE). A HFE comprises a tank containing the fluid fire suppressant and a gas generator cartridge. The fluid fire suppressant is propelled from the tank by the high-pressure gas generator discharge instead of supercharged nitrogen gas, typical of most pressurized fire suppression systems. The heat transfer between gas generator gases and fluid fire suppressant promotes a multiphase suppressant discharge, even at cold temperatures. Multiphase discharges are advantageous because gases, can more easily than liquids, go around objects to get to a fire. Liquids are advantageous in that liquids can spread in a film or layer over the burning fuel. Adjusting the gas generator design determines the time-dependent fire suppressant discharge flow rate and vapor quality. The principal advantages of an HFE include: increased fire suppressant flow rate control, improved fire suppressant distribution, a reduction of fire out times, elimination of a high-pressure nitrogen pressurant, higher fill density, improved cold temperature performance, insensitivity to orientation, increased safety, reduction in maintenance requirements, and elimination of a fast-actuating solenoid valve. A surfactant provided in the fluid fire suppressant will facilitate formation of a film at the combustible fuel/air interface to prevent reignition. Representative surfactants to use in the present invention are alkyl sulfonates and amine salts. The surfactant can also be a blend comprised of a mixture of a fluorocarbon and/or a hydrocarbon surfactant with alkyl polyglycosides and/or glycols.

Hybrid fire extinguishers require less fire suppressant than conventional systems. The solid propellant gas generator facilitates vaporization of a fluid fire suppressant improving dispersion upon discharge. Fire suppressant vaporization and distribution associated with hybrid extinguishers results in reduced agent concentration requirements as compared with nitrogen pressurized bottles. Additionally, storage volumes of liquid fire suppressants are considerably smaller than gaseous suppressants. Since the pressurizing gas generator is stored in solid form until activation, the HFE requires no nitrogen charging. Therefore, the storage pressure is much lower. Thermodynamically, the fluid fire suppressant loading density can be significantly increased without incurring the danger of overpressure at higher storage temperatures. As a result, the vehicle fire extinguisher can be packaged in a small volume. The combination of dispersion of a liquid fire suppressant via a solid propellant gas generator, reduced agent concentration requirements, the elimination of a nitrogen pressurant, and the reduced volume of a liquid agent make the hybrid system exceptionally well suited to be used in vehicles.

A hybrid fire extinguisher can discharge its entire fire suppressant load in hundreds of milliseconds (msec). In some instances, discharge time is less than 150 msec. This high rate of discharge provides the fluid fire suppressant with considerable momentum, which aids in flame front penetration, and provides an excellent dispersion of the suppressant and results in faster fire-out times.

HFEs can utilize chemically “active” solid propellant gas generators to provide additional fire suppression effectiveness, reduce system mass, and increase performance. Chemically “active” propellants are known for use on various military platforms and can provide a 40-60% fire suppressant weight reduction. HFEs can also utilize a chemically “active” liquid fire suppressant to reduce mass and increase performance margin.

The nature of a high rate HFE discharge is such that the liquid suppressant changes phase during the discharge. The initial pulse of suppressant discharges principally as very fine droplets. These droplets are large enough to have considerable momentum, which aids in dispersion distance and flame front penetration, yet are small enough to offer considerable surface area for heat abstraction from the fire. As the HFE continues to discharge, the liquid suppressant has had more time to absorb heat from the hot gases produced by the solid propellant gas generator. As such, the quality of this suppressant changes and reaches a higher vapor content. The suppressant vapor, along with the chemically active gas produced by the gas generator, behaves like a gas and is able to travel around obstructions to ensure that the fire is not able to hide from the discharge plume. This dual phase discharge is a characteristic of hybrid fire extinguisher technology. Both the hybrid fire extinguisher tank and the solid propellant gas generator inside the tank incorporate uniquely sized orifices and rupture disks to control discharge performance/timing and an environmentally hermetic seal.

Surfactants will facilitate formation of a film or blanket at the fuel/air interface to prevent reignition of the fuel. Water based fire suppressants may also include additives for anti-freeze protection. An HFE has no, or a very low, storage pressure, so personnel are no longer required to handle a highly pressurized steel or composite tank. The design is inherently safer to personnel. Without storage pressure, the result is reduced leakage, fatigue stresses and maintenance requirements, resulting in improved storage life and life cycle costs. Without the need for nitrogen as a pressurant, there are no solubility issues. The result is a longer system life. As compared to a pressurized system, the hybrid fire extinguisher has negligible mass flow rate (performance) variation across the operational temperature range. Unlike nitrogen pressurized fire extinguishers, hybrid fire extinguishers operate the same regardless of their orientation. The entire solid propellant gas generator can be replaced with a new unit (the old solid propellant, or the entire hybrid fire extinguisher can be discarded) and the tank can be refilled with liquid fire suppressant and surfactant. HFEs can be biodegradable and include non-ozone depleting/nontoxic fire suppressants.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an illustration of a fire suppression system according to the present invention installed in a vehicle;

FIG. 2 is an illustration of a fire suppression system for vehicles according to the present invention;

FIG. 3 is an illustration of a hybrid fire extinguisher suitable for use in a fire suppression system for vehicles according to the present invention; and

FIG. 4 is a schematic of a fire suppression system for vehicles according to the present invention.

### DETAILED DESCRIPTION OF THE PREFERRED EMBODIMENT

The following patents and applications describe some of the efforts made toward fire suppression systems: U.S. Pat. Nos. 5,423,384; 5,449,041; 6,045,637; 6,513,602; 6,076,468; 5,613,562; 6,217,788; 6,024,889; and WO 00/57959. All these patents are herein fully incorporated by reference in their entirety. These patents describe representative chemically active and inactive solid propellants that can be used for solid propellant fire extinguishers. Solid propellants also generate a gas that can be used as a propellant source in hybrid fire extinguishers.

The fire suppression systems according to the invention have either a solid fire extinguisher or a hybrid fire extinguisher that is configured to deliver a fire suppressant in the event of a collision, impact, actual fire, or loss of fuel or any other condition or combination of conditions selected from acceleration, deceleration, speed, time, temperature, fuel, fuel level, fire, smoke, light transmittance and optical signature. In addition, an instrument for sensing acceleration, deceleration, speed, time, temperature, fuel, fuel level, fire, smoke, light transmittance and optical signature can be connected to the solid or hybrid fire extinguisher via a processor to cause functioning of the fire extinguisher according to a predetermined logic. Suitable instruments include but are not limited to accelerometers, timers, thermocouples, level switches, level transmitters, infrared sensors, optical sensors, contact switches, speedometers and video sensors.

According to one embodiment of the present invention a solid propellant fire extinguisher can be utilized in the fire suppression system. Chemically active solid propellant fire extinguishers come in cartridges that can have a 2″ diameter and vary in length up to 15″ depending on the agent loading. The solid fire extinguisher gas is completely discharged from the cartridge within 200 milliseconds. This high rate of discharge provides the suppressant with considerable momentum, which aids in flame front penetration, provides an excellent dispersion of the suppressant and results in faster fire-out times. Testing has shown that this is very effective for suppressing uncontained fires typical of the vehicle underfloor application. However, it is possible to adjust the rate of discharge to more or less than the 200 milliseconds to suit the intended application of the fire extinguisher.

Solid propellant fire extinguishers (SPFEs) have numerous advantages. SPFEs pack more fire suppressant into less weight. Additionally, solid propellants offer the most volume efficient means to store a gas. The net effect is a much smaller and lighter device than can be achieved with a traditional nitrogen pressurized stored agent system. SPFEs provide consistent fire suppressant discharge profiles across the range of typical automotive temperature requirements. SPFEs do not require a nitrogen pressurant to deliver fire suppressant, hence there are no leakage concerns. The internal pressure of a SPFE remains at ambient until the fire extinguisher is activated. SPFEs will eliminate the logistics, maintainability, handling, and safety concerns associated with typical nitrogen pressurized stored agent bottles. SPFEs can utilize “active” agents to reduce mass and increase fire extinguishing and suppression performance. Chemically active agents compliment the cooling, inerting and flame strain of conventional SPFEs by incorporating constituents which interact with and eliminate flame propagating combustion intermediates. Representative additives include potassium salts, sodium salts, and halide salts including a bromide and/or iodide, or carbonates including hydrogen carbonate. Chemically active propellants are based on the already qualified fire suppression propellant that is used on various military platforms, while providing a 40-60% suppressant weight reduction. Additional SPFE attributes include being orientation and acceleration insensitive. SPFEs can be hermetically sealed (20 year shelf life); require little or no maintenance; are disposable; and are nontoxic, noncorrosive, and environmentally friendly. Representative examples of SPFEs that may be integrated in vehicles in a manner according to the invention are provided in U.S. Pat. Nos. 6,045,637; 5,613,562; 6,217,788; and 6,024,889, incorporated herein by reference in their entirety.

One drawback with SPFEs is that they may not adequately eliminate the potential for reignition of any remaining pooled fuel. Given the desire to reduce the reignition potential, it is desirable to discharge a fluid, film or foam capable of blanketing the fuel puddle surface with a solution containing a surfactant or a substance that alters the flammability characteristics of the fuel. Selected surfactant solutions may be added to liquid fire suppressants in hybrid fire extinguishers. The surfactants will facilitate formation of a film or blanket at the fuel/air interface to prevent reignition of the fuel. Alternatively, surfactants may prevent initial ignition of the fuel. A surfactant can be incorporated into a hybrid fire extinguisher (HFE) in the fluid fire suppressant much more readily than it can in a solid propellant fire extinguisher.

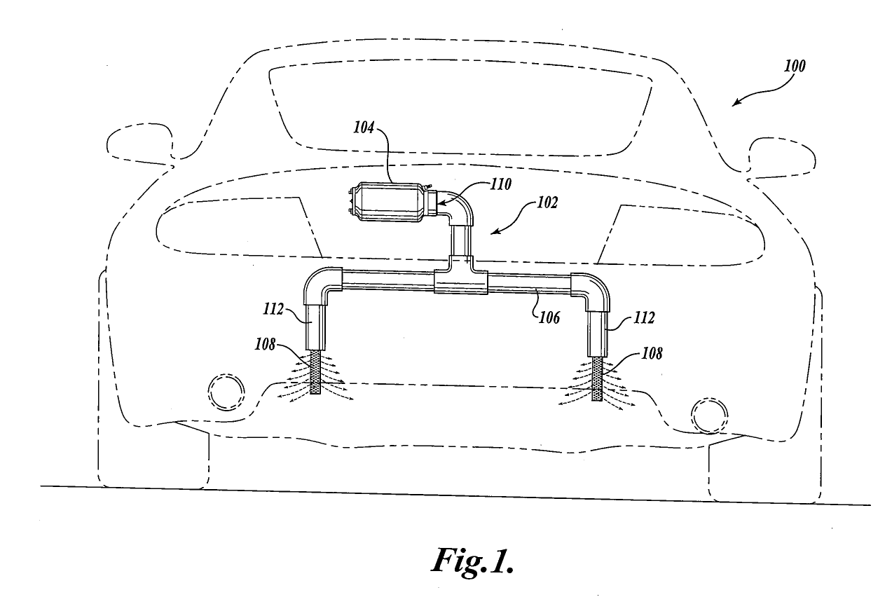

Referring now to FIG. 1, an illustration of a vehicle 100 with a fire suppression system 102, according to the present invention, is illustrated. As shown, the fire suppression system 102 is installed in the rear of the vehicle at any location that is suitable to withstand a collision meaning that the structural member or members to which the fire suppression system 102 or its ancillary equipment is installed, does not experience substantial deformation so as to hamper the functioning of the fire suppression system 102. In one embodiment, the fire suppression system can be installed in the trunk compartment of a vehicle. Any buttressing structural members can be provided in addition to the structure already present so as to provide the structural integrity to the fire suppression system 102.

The fire suppression system, according to the present invention, includes a tank 104 containing a solid propellant gas generator cartridge, a volume of fluid fire suppressant, and an additive or surfactant. The discharge of the tank 110 is connected to piping 106 that leads to discharge nozzles 108 directed at locations at or near the ground surface. Alternatively, other embodiments may have nozzles directed upwards, for example, into the passenger compartment to suppress fires in the passenger compartment. FIG. 1 shows one embodiment of nozzles as telescoping nozzles 108. Telescoping nozzles 108 are in the fully extended position that allows the multi-phase fluid fire suppressant and inert gasses generated by the solid propellant to be discharged therefrom and into the flame front, typically, being toward the undercarriage of the vehicle 100. In the non-functioning state, telescoping discharge nozzles 108 will be retracted inside of the pipe ends 112. Telescoping nozzles 108 can be retracted inside of pipe ends 112 so as to avoid damage from any road debris that may strike the undercarriage of the vehicle during normal driving. When the fire suppression system is activated, the pressure generated by the gases will be sufficient to force the telescoping discharge nozzles 108 downward to allow escape of multiphase fluid fire suppressant and inert gasses from apertures provided in the discharge nozzles 108.

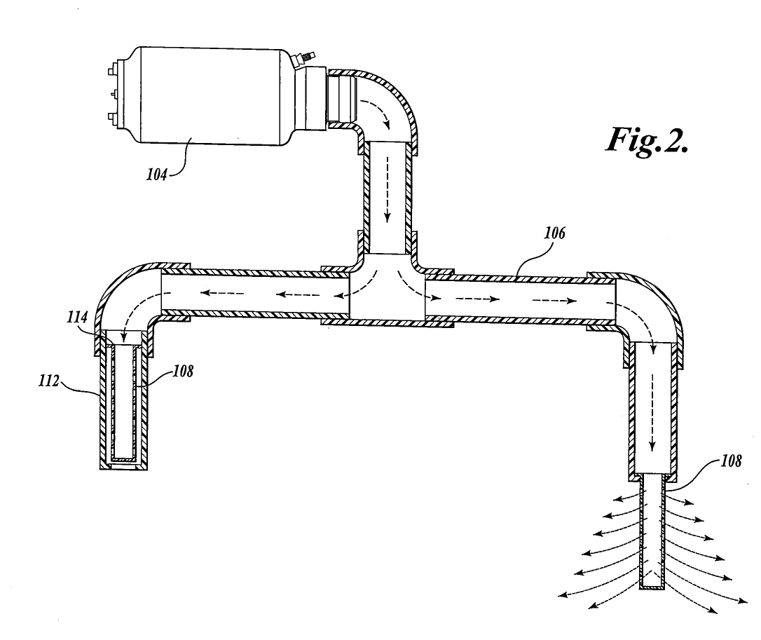

Referring now to FIG. 2, a fire suppression system for vehicles according to the present invention is illustrated. As can be more clearly seen, the left-hand side discharge nozzle 108 is shown fully retracted into the pipe end 112. Telescoping nozzle 108 may include a sleeve 114 that is about the size of the interior diameter of the pipe end 112. Sleeve 114 is connected to the upper end of the telescoping nozzle 108. Sleeve 114 guides the telescoping nozzle 108 downward through a hole in the end of pipe end 112 into the position shown in the right-hand telescoping nozzle, also designated by the same reference numeral 108. Sufficient pressure is generated by the solid propellant within tank 104 to enable the telescoping nozzles 108 to extend from the fully retracted position to the fully extended position, thus allowing the multiphase fluid fire suppressant and inert gasses to exhaust from the apertures provided in the discharge nozzles 108.

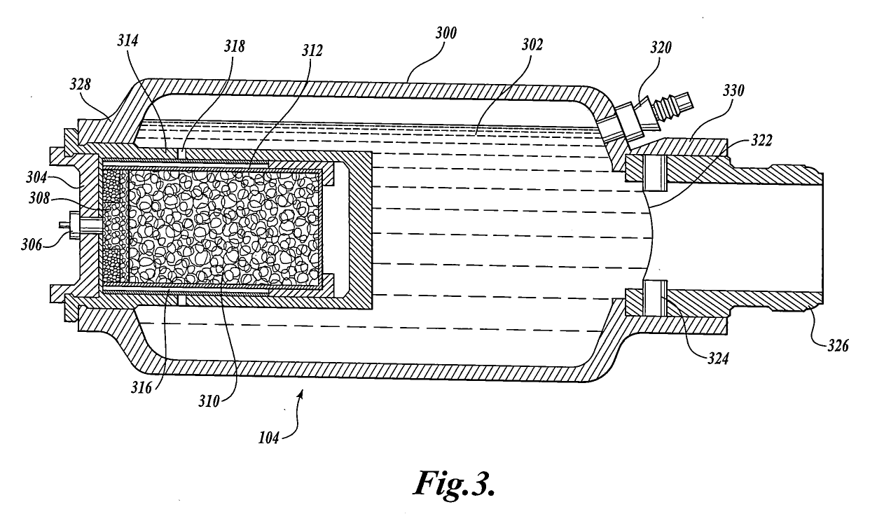

Referring now to FIG. 3, the fire extinguisher according to the present invention includes a gas generator breach 314 coupled to the tank 300 at a tank opening 328 at one end of the tank 300. Solid propellant tube 312 is placed within the gas generator breach 314. Both solid propellant tube 312 and gas generator breach have holes to allow the passage of gases on activation. The breach 314 is closed by an enclosure 314. Enclosure 304 is fitted with a primer or initiator 306 that is in contact with the propellant within the tube 312. The primer or initiator 306 can be connected to electronic or mechanical initiation systems. In one embodiment, the hybrid fire extinguisher can be activated using a pyrotechnic initiator that functions upon receipt of an electric signal that is similar to the initiators used in airbag systems. The tank 300 includes a volume of fluid fire suppressant 302 that contains a surfactant or additive as further described below.

The solid propellant tube 312 includes a booster propellant 308. The solid propellant tube 312 also houses the main propellant 310. The solid propellant tube 312 is housed within the gas generator breach 314 that is in the interior of the tank 300. The tube 312 has perforations distributed along its walls to provide for the escape of gases. The gas generator breach 314 is provided with orifices 318 in a radial pattern along its circumference. Burst shims 316 are welded, brazed, or otherwise bonded to the breach 314 to cover the orifices 318. The burst shims 316 are ruptured when sufficient pressure forms within the breach 314 after ignition of the propellants to allow the escape of inert gases into the tank 300 where the gases pressurize the tank and cause the fluid fire suppressant to be propelled therefrom. The fluid fire suppressant and surfactant is prevented from contacting the solid propellant by the burst shims 316 that separate the solid propellant tube 312 from the fluid fire suppressant and surfactant 302. The tank 300 further includes fill ports 320 that can be located at any suitable and convenient location to replace and refill the contents of tank 300 with any suitable fluid fire suppressant and surfactant 302.

The tank 300 includes an outlet 330 through which multiple phases may pass on activation of the fire suppression system. Gases generated by the solid propellants and any vaporized gases attributed to the fluid fire suppressant and surfactant, and any atomized liquids or liquids can be expelled through outlet 330. As shown, the outlet 330 includes a rupture disk 322 that has a predetermined pressure limit at which the disk 322 ruptures or opens. Alternatively, a pressure relief valve or poppet valve may be used in place of a rupture disk. Preferably if a rupture disk is used, no fragments are generated upon rupture that may prevent clogging of distribution pipes or discharge nozzles. An orifice plate 324 is also mounted within the interior of the outlet 320. The orifice plate area determines the vapor and liquid flow so as to throttle any gases or liquids at a predetermined discharge rate or for a predetermined time period. The outlet 320 in the tank 300 is also connected to a pipe fitting 326 to couple the fire extinguisher tank 300 to the remainder of the system components including the distribution pipes and discharge nozzles placed at strategic locations on the underside of the vehicle body or at any other desirable location.

The fire suppression system and distribution piping can be mounted in a convenient location outside of the vehicle crumple zones that increases the likelihood that it will not be damaged by the impact of collision. The piping used for the distribution lines will have sufficient flow area to accommodate the high mass flow rate associated with the rapid discharge event and be designed for the internal pressures associated with the discharge. Nozzles are located underneath the vehicle such that the discharge plume adequately covers the entire potential fuel puddle area. Ideally, the nozzles will be mounted forward of the rear axle, or in any location that is outside of the vehicle's crumple zones such that they are not damaged during the collision impact and the resulting crumpling of the vehicle's body. The nozzles have caps that are designed to keep debris out and are designed to pop off or open during the discharge event.

For operation as a fire extinguisher 104 in the fire suppression system shown in FIGS. 1 and 2, the tank 104 contains a fluid fire suppressant 112 that is fully or partially volatizable on contact with the hot combustion gases produced from the gas generator tube 312. Suitable fire suppressants are disclosed in the International Application No. PCT/US00/05953 as well as in the other applications and patents mentioned above. Representative fire suppressants include perfluorocarbons (PFCs) and hydrofluorocarbons (HFCs). A preferred fire suppressant is known under the designation HFC-227ea (CF₃CHFCF₃) (1,1,1,2,3,3,3-Heptafluoropropane), or any equivalent thereof. Water-based fire suppressants may also be used in hybrid fire extinguishers pending design, performance, and environmental evaluations. A preferred water-based fire suppressant includes water, potassium acetate (as a freezing point depressant), and a surfactant.

The liquid fire suppressant can been selected for its cooling characteristics and can include additives to reduce the freezing point and reduce fuel reignition via a surfactant or other chemical means to alter the fuel's ignition properties. Additives to enhance the action of surfactants, promote foam formation, stabilize the blend for long-term storage, and improve biodegradability may be optionally included.

Fluid fire suppressants used for suppression of liquid hydrocarbon-fuel fires, such as gasoline fires, are ideally capable of extinguishing the fire and preventing fire relight. Extinguishment is typically achieved by the initial discharge of the fire suppressant, while re-ignition is achieved by reducing the volatility of the fuel. This is typically accomplished by using suppressants that can cool the fire, e.g., water, and fluorocarbon agents. According to the invention, reduced volatility can also be affected using wetting and/or foam-forming additives and surfactants that form a layer on the fuel surface and inhibit fuel vaporization. Traditional fluorocarbon fire fighting agents, e.g., Halon-1301, while showing some effectiveness in extinguishing fires, are less effective in protecting against fire relight. This is attributed to the low boiling point of typical fluorocarbons, resulting in their rapid vaporization and diffusion away from the fuel zone. Water-based fire suppressants are effective in extinguishing the fire, but poor miscibility of water with hydrocarbon fuels limits water's effectiveness in suppressing relight, unless large quantities of water are used. According to the invention, surface active agents, or surfactants, can be mixed into the water or other liquid fire suppressant to mediate water-hydrocarbon/fuel mixing. This mixing may take the form of a uniform layer of water atop a pool of hydrocarbon fuel. Ideally, these surfactants are optimized for facilitating the mixing of water with automotive fuels, for example. Furthermore, these surfactants can be effective in water-based systems that are modified with antifreeze agents in order to meet low temperature discharge requirements of commercial automotive applications. Antifreeze agents typically depress the freezing point in liquids with which they are mixed. Representative antifreeze agents include ethylene glycol, propylene glycol, or salts, including potassium acetate, calcium chloride, potassium lactate and ammonium acetate. Surfactant blends are water based, are preferably nonflammable and include petroleum and oleochemical derivatives of sulfonates and amine salts, long-chain fatty carboxylic acids and their salts, nonionic surfactants such as block copolymers of propylene oxide/ethylene oxide, amphoteric surfactants such as betaines, as well as mixtures of different surfactants. Surfactants can be mixed with a fluorocarbon and/or hydrocarbon surfactants with alkyl polyglycoside and/or glycols. Suitable surfactants for use in the present invention are described in Kirk-Othmer, CONCISE ENCYCLOPEDIA OF CHEMICAL TECHNOLOGY, 4.sup.th ed., John Wiley & Sons, Inc., pub., 1999, pp. 1949-1953, incorporated herein expressly by reference in its entirety.

A representative solid propellant 310 includes a compacted mixture of a nitrogen-containing solid fuel, such as 5-aminotetrazole, a solid oxidizer, such as strontium nitrate, and a solid coolant, such as magnesium carbonate. Representative fuels include aminotetrazoles, 5-amino-tetrazole and the potassium salt thereof, guanidine nitrate, aminoguanidine nitrate, triaminoguanidinium nitrate, nitroguanidine, ammonium nitrate, dicyanodiamide, oxamide and combinations thereof. Representative oxidizers include ammonium, sodium, potassium and/or strontium nitrates; ammonium and/or potassium perchlorates; ceric ammonium nitrate and combinations thereof. Representative coolants include magnesium carbonate, magnesium hydroxide, magnesium hydroxide carbonate, aluminum hydroxide and combinations thereof.

The coolant serves to keep the temperature of the combustion gases sufficiently low to avoid an unwanted degree of vaporization or thermal decomposition of the fire suppressant in order to keep the fluid fire suppressant 302 discharged from the fire extinguisher 104 at a relatively safe temperature for incidental contact with any nearby persons. A preferred propellant 310 can be provided from Aerojet of Redmond, Wash., under the designations FS01-00, FS01-40, PAC 3304, and PAC 3303. Other suitable propellants and adjuvants, and their amounts, for use in the propellant tube 312 are listed in the U.S. Pat. Nos. 6,024,889; 5,613,562; 5,449,041; 5,423,384; and 6,217,788 and International Application Nos. PCT/US94/06622 and PCT/US00/05952.

The solid propellant 310 and/or booster propellant 308, if provided, are ignited by an initiator assembly 306. A suitable initiator assembly 306 is described in the International Application No. PCT/US00/05953. The initiator 306 causes sufficient heat, and/or a shock wave which causes ignition of the propellants.

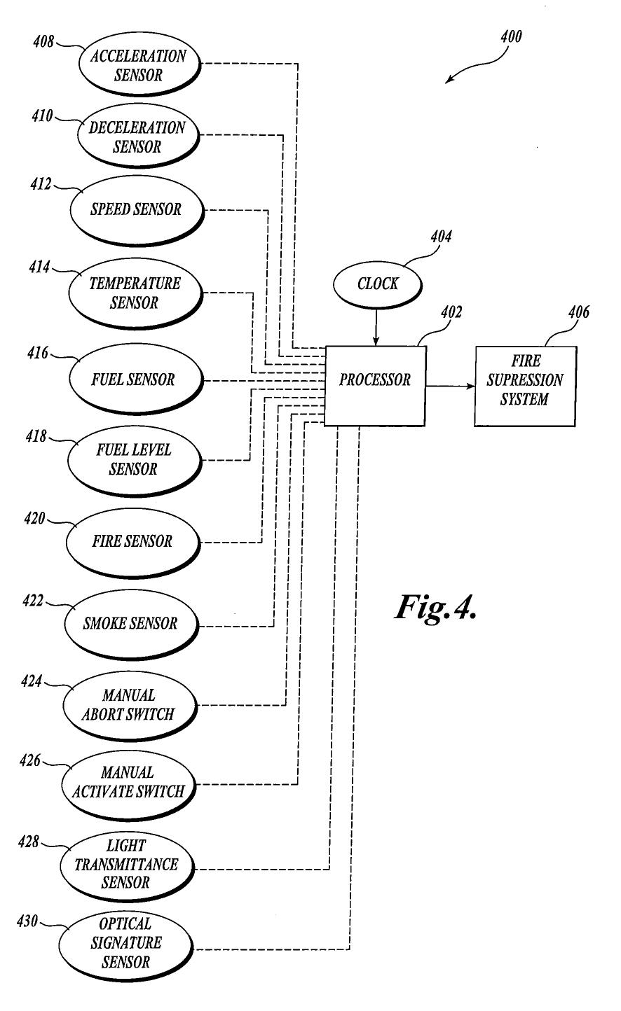

Referring now to FIG. 4, a schematic of the firing system for the fire suppression system according to the present invention is illustrated. The firing system 400 includes a processor 402, and may include an internal clock 404 for timing of certain events or conditions. The processor 402 generates a signal that is transmitted to the fire suppression system 406 that indicates that fire suppression system 406 is to be activated. The processor 402 can receive input from one or more instruments 408-430. Voting logic can be soft or hard wired into the processor 402. Voting logic may depend on one or more conditions being satisfied as indicated by one or more instruments, as well as timed events or timing after the one or more conditions are met. Instruments that may feed the processor include, but are not limited to accelerometers, clocks, thermocouples, level switches, level transmitters, infrared sensors, optical sensors, contact switches, speedometers and video sensors.

The processor 402 that controls the operation and functioning of the fire extinguisher can include built in test logic, status indication, and firing logic (manual and automatic). Toward that end, the fire suppression system is connected to one or more instruments that can indicate acceleration, deceleration, speed, time, temperature, fuel, fuel level, fire, smoke, light transmittance and optical signature. A manually operated dashboard mounted “crash” switch can disable the functioning of the fire suppression system even though the firing logic and instruments may indicate that activation of the fire suppression system is desirable. Alternatively, the same or different manual switch may be used to activate the fire suppression system even though the firing logic and instruments may indicate that the activation of the fire suppressant system is not desirable. The switch can operate to function the fire extinguisher or the switch can be used to abort the functioning of the fire extinguisher.

An acceleration sensor 408 or deceleration sensor 410 can be provided to detect a collision. A stationary or moving vehicle will accelerate quickly when impacted by another faster moving vehicle. Alternatively, a moving vehicle will decelerate quickly if it collides with a stationary object. Acceleration or deceleration sensors will be able to detect any of these conditions. Either alone or in combination with other instruments, the acceleration and/or deceleration sensor can activate the fire suppression system 406.

Additionally or alternatively, a speed sensor 410 can be configured to signal the processor 402. Speed sensor 410 can indicate when a vehicle has stopped or is about to come to a stop. Knowing when a vehicle is stopped or coming to a stop after a collision is important since activation of the fire suppression system at such time takes place where it is most likely that fuel has been spilled or will accumulate underneath the vehicle. In this respect, the speed sensor 410 signal can be combined with any other instruments, such as an acceleration sensor. Alternatively, the speed sensor 410 can be used to initially enable the fire suppression system. For example, the processor 402 can be configured to monitor the speed continuously to determine whether the speed of the vehicle immediately prior to a collision is above a predetermined speed. If the vehicle has not reached the minimum speed, the fire suppression system will not be enabled to function regardless if an acceleration is detected that would otherwise activate the fire suppression system. For example, if the speed of the vehicle is 35 mph immediately before the collision, the fire suppression system will not function, even though an acceleration or deceleration sensor may actually indicate that a collision has occurred. However, if the speed sensor monitors the speed of the vehicle at above 40 mph, then, the fire suppression system 406 will function on the appropriate acceleration or deceleration condition. A lower speed limit to initially enable the fire suppression system 406 can be anywhere in the range of 5 mph up to 60 mph. Other embodiment of the fire suppression system can have the range of 5 mph to 40 mph. Requiring a minimum speed to be reached is to protect from accidental activation of the fire suppression system because there is a speed below which regardless if a collision occurs, the speed of the vehicle is so low that it is unlikely to cause breach of the fuel tank. Furthermore, if a timed delay is used after monitoring an acceleration or deceleration condition indicating a collision, the timed delay can be increased for every increment of speed above the minimum. For example, for every 1 mph faster that the vehicle is travelling, 1/10th of a second will be added to the timed delay activation of the fire suppression system. It is not necessary that the timed delay be linearly related to the speed, since energy is a function of the square of the velocity, and therefore a square root function may be used to compute the timed delay from the speed.

A temperature sensor 414 can provide an additional signal to the processor 402 that is indicative of an actual fire. The temperature sensor 414 signal can be used alone or in combination with other instrument conditions to activate the fire suppression system 406. For example, after an acceleration or deceleration condition, a temperature sensor can be used to confirm the existence of an actual fire to improve the reliability of the fire suppression system.

A fuel sensor 416 or gasoline detector can provide an additional signal to the processor 402 that confirms the existence of spilled fuel. The fuel sensor 416 can be used alone or in combination with other instruments to activate the fire suppression system 406. As discussed above, it is important to extinguish a fire if there is one, but it is equally important to prevent the ignition of a fire in the first instance or prevent reignition. A fuel sensor will be able to detect spilled fuel after a collision, even in the absence of a real fire. Detecting loss of fuel may be done by instruments that monitor the level of fuel in a vessel or alternatively, vapor analyzers can detect the presence of flammable vapors attributable to fuel. Fuel sensor 416 detects the presence of flammable vapors in the surrounding environment which is indicative of a fuel spill. The fuel sensor 416 can indicate that the fire suppression system should be activated to blanket the spilled fuel with fluid fire suppressant that preferably will contain a surfactant that will interpose itself between the air fuel interface to prevent the ignition of the fuel.

Alternatively, a fuel level sensor 418 mounted in the fuel tank of a vehicle can be used to provide a signal to the processor 402 that fuel has been spilled after a collision. The fuel level sensor can be used alone or in combination with other instruments to activate the fire suppression system 406. A fuel level sensor 418 is an alternative to detection of fuel by the fuel sensor 416, and so a fuel level sensor 418 can replace or backup the fuel sensor 416. Fuel level sensor 418 can indicate a condition to activate the fire suppression system if, for example, a rapid decrease in the fuel tank level is detected, or if the fuel tank level indicates the absence of any fuel.

A fire sensor 420 can provide a signal to the processor 402 that is indicative of an actual fire. A fire sensor can be related to the measurement of temperature or detection of smoke, but a fire sensor can mean any other method of detecting a fire. Such sensors may include video cameras, infrared sensors, fusible materials as are found in some sprinkler systems. The fire sensor 420 can be used alone or in combination with other instruments to activate the fire suppression system. For example, after an acceleration or deceleration condition, a fire sensor can be used to confirm the existence of an actual fire.

A smoke sensor 422 can provide a signal to the processor 402 that is indicative of an actual fire. A smoke sensor should be able to discern the smoke from a fire as opposed to dust produced by a sliding or skidding vehicle. The smoke sensor 422 can be used alone or in combination with other instruments to activate the fire suppression system 406. For example, after an acceleration or deceleration condition, a smoke sensor 422 can be used to confirm the existence of an actual fire.

A manual abort switch 424 can be used to disable the functioning of the fire suppression system 406 regardless if any other instrument indicates of a fire, collision or fuel spill condition. In addition, manual abort switch 422 can be used to disable the fire suppression system 406 when the fire suppression system 406 is being serviced to prevent possible injuries to the worker of the vehicle from the accidental activation of the fire suppression system. It is possible however, that manual abort switch may not fully abort the fire suppression system if it is deemed that there are conditions which indicates activation of the fire suppression system regardless of the manual abort switch condition. Manual abort switches are known and widely used to disable a variety of potentially dangerous equipment or systems when the equipment or system is desired to remain under human control.

A manual activate switch 426 can be used to activate the fire suppression system 406 regardless if any other instrument does not indicate a fuel spill, fire, or collision condition. It is possible however, that manual activate switch 424 cannot fully override all other instruments if it is deemed that there are conditions which indicates that the fire suppression system should not be activated unless certain conditions are met.

Light transmittance sensor 428 and optical signature sensor 430 are instruments to measure a quality or property of light or of the atmosphere. The light transmittance sensor 428 or the optical signature sensor 430 can be used alone or in combination with other instruments to activate the fire suppression system 406. For example, after an acceleration or deceleration condition, a light transmittance sensor 428 or optical signature sensor 430 can be used to confirm the existence of an actual fire.

Finally, a timer for keeping track of when conditions are met, and for measuring the time for time dependent actions can also be provided. For example, as discussed above, a rapid acceleration or deceleration condition alone may not activate the fire suppression system until a time delay period has expired. The delay in activation of the fire suppression system is to provide the vehicle a certain amount of time to slow down or come to a stop to where it can be reasonably certain that the majority of the fuel will pool. By delaying the activation of the fire suppression system, it is predicted that the fluid fire suppressant with surfactant will be applied to the majority of the pooled fuel.

As is readily apparent from this disclosure, one or more instruments can detect conditions that either alone or in combination with other instruments' detection of other conditions can signify acceleration, deceleration, speed, time, temperature, fuel, fuel level, fire, smoke, light transmittance and optical signature that warrants the activation of a fire suppression system. The use of computers with processors makes it possible to use a predetermined firing logic to take any one or more instrument conditions and use a voting logic with suitable interlocks and time delays to enable reliable and automatic activation of the fire suppression system 406.

A few of the possible firing logic algorithms have been described herein. Other firing logic sequences based on the disclosed instruments are to be considered within the scope of the present invention.

### EXAMPLES

Fire testing has been conducted using vehicles under various conditions, including varying fuel quantity and the use of stationary versus moving vehicles and various reignition conditions.

| Example | System | Fire Scenario | Agent | Delivery | Result |
|---|---|---|---|---|---|
| 1 | SPFE | 200 mL/min leak | 515 g CA¹-SPFE | radial spray | fire |
| | | puddle 3 ft below | | | extinguished |
| | | discharge. | | | |
| 2 | SPFE | 200 mL/min leak | 347 g CA-SPFE | radial spray | fire not |
| | | puddle 3 ft below | | | extinguished |
| | | discharge. | | | |
| 3 | SPFE-1 | 30 s preburn fuel flow | 2 * 1 lbm CA | | Fire |
| | | 30 ft fuel stream | SPFEs | | knockdown |
| | | 5-10 sec preburn | | | Flashback/ |
| | | | | | relight |
| 4 | HFE-1 | 30 s preburn fuel flow | 2 * 5 lbm HFC- | 2 * 1 lbm | Fire |
| | | 30 ft fuel stream | 227 | SPGG | knockdown |
| | | 5-10 sec preburn | 2 * 250 g | 2 nozzles | Flashback/ |
| | | | NaHCO₃ | | relight |
| 5 | HFE-2 | 30 s preburn fuel flow | 2 * 7 lbm | 2 * 1 lbm | Fire |
| | | 30 ft fuel stream | aqueous | SPGG | knockdown |
| | | 5-10 sec preburn | antifreeze- | 3 nozzles | Relight/ |
| | | | surfactant blend | | flashback |
| | | | | | suppression |
| 6 | Powder | 30 s preburn fuel flow | Powdered | SPFE | Fire |
| | Sys. | 30 ft fuel stream | KHCO₃ | | knockdown |
| | | 5-10 sec preburn | | | Flashback/ |
| | | | | | relight |
| 7 | Foam | 30 s preburn fuel flow | 8o lbm Aq. | 2+ min | Fire |
| | Sys. | 30 ft fuel stream | foam blend | N₂ | knockdown |
| | | 5-10 sec preburn | | pressurant | Relight/ |
| | | | | | flashback |
| | | | | | suppression |

¹CA means “chemically active”

The examples demonstrate that solid propellant fire extinguishers (SPFEs) are capable of knocking down fire, but are less successful at preventing a reignition event. A liquid or foam based system that provides a surfactant coating over the remaining fuel puddle is a more successful technique. Tested surfactants include common liquid dishwashing detergents that may be added to the liquid fire extinguishing or suppression agent. Additionally, the examples demonstrate the advantage of the quick discharge and excellent dispersion provided by a solid propellant based technology.

The hybrid fire extinguisher includes a solid propellant gas generator, which is used to pressurize, vaporize, and expel fire extinguishing and suppressing agent and surfactant from a cylinder. In one embodiment, the gas generator incorporates chemically active propellant and a liquid fire suppressant that includes chemical activity plus a surfactant to aid in suppression of the fire and prevention of reignition of any fuel remaining underneath the vehicle.

While the preferred embodiment of the invention has been illustrated and described, it will be appreciated that various changes can be made therein without departing from the spirit and scope of the invention.

We claim:

1. A fire extinguisher, comprising: a container containing a propellant and a fluid fire suppressant, wherein the propellant is functional to propel the fluid fire suppressant from the container; and a surfactant in the fluid fire suppressant to enhance the film-forming capability of the fluid fire suppressant on a fuel.

2. A fire suppression system for a vehicle, comprising: a fire extinguisher according to claim 1; an instrument capable of indicating a condition selected from the group consisting of acceleration, deceleration, speed, time, temperature, fuel, fuel level, fire, smoke, light transmittance and optical signature; and a processor to activate the fire extinguisher based on an indication of one or more conditions.

3. The fire suppression system of claim 2, further comprising distribution pipes connected to the fire extinguisher container to deliver the fluid fire suppressant to nozzles placed in locations to discharge on a fuel spill.

4. The fire suppression system of claim 2, wherein the instrument comprises an acceleration or deceleration sensor and a speed sensor, and the processor activates the fire extinguisher according to at least an acceleration or deceleration condition indicative of a collision and a speed condition indicative of the vehicle slowing down.

5. The fire suppression system of claim 2, wherein the instrument comprises a speed sensor and the processor activates the fire extinguisher according to a speed condition that is indicative of the vehicle stopping.

6. The fire suppression system of claim 2, wherein the instrument comprises a speed sensor and the processor activates the fire extinguisher according to a speed condition that is indicative of the vehicle slowing down.

7. The fire suppression system of claim 2, wherein the instrument comprises an acceleration or deceleration sensor, a speed sensor, and a timer, and the processor activates the fire suppression system provided the vehicle has reached a minimum speed condition, and the time delay after an acceleration or deceleration condition indicative of a collision is adjusted according to the speed that is in excess of the minimum speed at the time of collision.

8. The fire suppression system of claim 2, wherein the instrument comprises an acceleration or deceleration sensor and a fire sensor, and the processor activates the fire suppression system according to a condition of acceleration or deceleration indicative of a collision and a condition of fire being detected.

9. The fire suppression system for a vehicle of claim 3 wherein said reservoir includes a gas generator effective to generate a propellant for establishing a pressure effective to deliver said fire suppressant agent to said distribution system.

10. The fire suppression system for a vehicle of claim 9 wherein said gas generator is a pyrotechnic gas generator.

11. The fire suppression system for a vehicle of claim 10 wherein said propellant is selected to be a solid.

12. The fire suppression system for a vehicle of claim 9 wherein said at least one location about said body includes an underside of said vehicle body.

13. The fire suppression system for a vehicle of claim 11 wherein said at least one location about said body includes an underside of said vehicle body.

14. An automotive vehicle, comprising:
a vehicle body;
a reservoir containing a fire suppressant agent, with said reservoir being mounted in proximity to said body;
a distribution system for receiving the fire suppressant agent from said reservoir and for conducting the fire suppressant agent to at least one location about said body;
a sensor system for determining whether the vehicle has been subjected to an impact and whether the vehicle is moving subsequent to such an impact; and
a controller, operatively connected with said sensor system and said reservoir, for causing said reservoir to initiate delivery of the fire suppressant agent from the reservoir to the distribution system.

15. The automotive vehicle of claim 14 wherein said reservoir includes a gas generator effective to generate a propellant for establishing a pressure effective to deliver said fire suppressant agent to said distribution system.

16. The automotive vehicle of claim 15 wherein said gas generator is a pyrotechnic gas generator.

17. The automotive vehicle of claim 16 wherein said propellant is selected to be a solid.

18. The automotive vehicle of claim 15 wherein said at least one location about said body includes an underside of said vehicle body.

19. The automotive vehicle of claim 16 wherein said at least one location about said body includes an underside of said vehicle body.

20. A method for activating a fire suppression system installed in a vehicle, such as a passenger automobile, comprising the steps of:
detecting a collision with a sensor;
sensing when a vehicle is coming to a stop after a collision; and
activating the fire suppression system to discharge a volume of fire suppressant from a tank installed in the vehicle based on vehicle speed or a lack thereof after said collision.
